(19) United States
(12) Patent Application Publication
(10) Pub. No.: US 2021/0001917 A1
(43) Pub. Date: Jan. 7, 2021

(54) POWER STEERING SYSTEM WITH END STOP FOR BLOCKING NUT INTEGRATED TO THE REDUCER CASING

(71) Applicant: JTEKT EUROPE, Irigny (FR)

(72) Inventors: Mickael GUERIN, Brindas (FR); Michael DUCHENES, Lyon (FR)

(73) Assignee: JTEKT EUROPE, Irigny (FR)

(21) Appl. No.: 16/919,218

(22) Filed: Jul. 2, 2020

(30) Foreign Application Priority Data
Jul. 2, 2019 (FR) 19/07330

(51) Int. Cl. B62D 3/04; B62D 5/04; B62D 3/12

(52) U.S. Cl. CPC B62D 3/04; B62D 3/12; B62D 5/0421

(57) ABSTRACT

A power steering system for a motor vehicle, including: a steering module including a steering casing inside which a steering rack is slidably mounted; and an assist module including a reducer casing fastened on a dome of the steering casing and inside which a gear reducer is mounted, including a worm screw driven by an assist motor and which meshes on a worm wheel linked in rotation to an output shaft with a pinion engaged with the steering rack and rotatably mounted in a rolling bearing carried by a bearing on the reducer casing, and a blocking nut is screwed inside the bearing in abutment against the rolling bearing, this nut being disposed facing an inner face of the dome from which at least one end stop protrudes opposite to the nut at a distance (DJ) allowing the nut to stop in the case of loosening.

The invention relates to a power steering system for a motor vehicle.

Conventionally, a power steering system comprises a rack and pinion steering module provided with a steering casing inside which a steering rack is slidably mounted, having two ends provided to be coupled to respective steering tie rods, themselves coupled to ball joint housings on the wheel side associated respectively to the right and left steered wheels of the motor vehicle.

In order to ensure the assistance, an assist module is also provided, comprising a reducer casing fastened to the steering casing and inside which a gear reducer is mounted, comprising a worm screw driven by an assist motor, generally electric, and which meshes on a worm wheel linked in rotation to an output shaft provided with a pinion engaged with the steering rack. Thus, an additional motor torque (or possibly a resisting torque) can be transmitted to the output shaft, and therefore to the pinion engaged with the steering rack, this additional torque being added to the torque exerted manually by the driver of the motor vehicle, on the steering wheel linked to the steering column coupled to the steering rack.

Specifically, the output shaft is rotatably mounted inside the reducer casing and the steering casing by means of at least one first rolling bearing carried by a first bearing provided on the reducer casing between the worm wheel and the pinion, and a blocking nut is screwed inside the first bearing in abutment against the first rolling bearing.

This clamping nut has the function of blocking the first rolling bearing by maintaining a clamping pre-load on this first rolling bearing, such that this first rolling bearing is constrained in the first bearing of the reducer casing. However, it is observed that a blocking nut alone, conventionally made of steel, does not allow ensuring maintaining the clamping pre-load in a reducer casing generally made of aluminum regardless of the temperature, and particularly at high temperature. Indeed, at high temperature, the difference in material (aluminum/steel) and therefore in coefficient of thermal expansion leads to a loss of the clamping pre-load exerted by the blocking nut on the first rolling bearing.

In order to respond to this problem of loss of the clamping pre-load, it is therefore known to use either a crimping of the blocking nut on the first bearing of the reducer casing, or a lock nut added after the blocking nut (such that this blocking nut is interposed between the first rolling bearing and the lock nut), in order to guarantee a non-loosening of the blocking nut and thus promoting maintaining the clamping pre-load exerted by the blocking nut on the first rolling bearing regardless of the temperature (including at high temperature).

However, the solution with crimping is not satisfactory, because the good quality of the crimping is only controllable today by a destructive method, such that it is impossible to control all parts and thus guarantee the good realization of this crimping. Also, if the crimping is not carried out correctly, the risks of loosening the blocking nut and therefore of losing (by complete unscrewing) this blocking nut are high.

Furthermore, the solution with a lock nut is also not satisfactory, mainly due to the additional cost generated by using an additional part, the lock nut, and by the additional operation of mounting the lock nut.

The invention proposes to solve all or part of the aforementioned drawbacks, by proposing a solution which allows guaranteeing that the blocking nut will not be completely loosened despite the thermal expansions.

Another object of the invention is to propose an inexpensive solution, in particular by allowing dispensing with a lock nut.

To this end, the invention proposes a power steering system for a motor vehicle, comprising:
a rack and pinion steering module comprising a steering casing inside which a steering rack is slidably mounted, having two ends provided to be coupled to respective steering tie rods, in which the steering casing has an open dome enabling an access to the steering rack; and
an assist module comprising a reducer casing fastened on the open dome of the steering casing and inside which a gear reducer is mounted, comprising a worm screw driven by an assist motor and which meshes on a worm wheel linked in rotation to an output shaft provided with a pinion engaged with the steering rack, this output shaft being rotatably mounted inside the reducer casing and the steering casing by means of at least one first rolling bearing carried by a first bearing provided on the reducer casing between the worm wheel and the pinion, and a blocking nut is screwed inside the first bearing in abutment against the first rolling bearing, said blocking nut being disposed facing an inner face of the open dome of the steering casing;

the power steering system according to the invention being remarkable in that the reducer casing has at least one end stop protruding from the inner face of the open dome and disposed facing the blocking nut at a predetermined distance allowing the blocking nut to stop in the case of unscrewing, such that this blocking nut can be unscrewed only partially before being stopped against this at least one end stop.

Thus, the invention proposes a solution which overcomes the aforementioned drawbacks, by proposing, inside the steering casing, a specific shape (the end stop(s)) opposite to the blocking nut which allows dispensing with the lock nut described above and which allows that, in the case of failure, the blocking nut might be loosened only partially.

Thus, if the blocking nut is loosened, it will come against the at least one end stop, which will possibly generate a noise, but in no case a complete failure, because at least one end stop allows avoiding a complete unscrewing of the blocking nut and therefore a loss of the nut, with the consequence of avoiding a loss of hold of the output shaft and a breakage or a malfunction of a portion of the power steering system.

With the invention, the user will even be warned of the loosening of the blocking nut by a noise (due to the contact between the blocking nut and the at least one end stop), advantageously allowing intervening quickly on the power steering system by opening the reducer casing and by tightening the lock nut.

According to one feature, at least one end stop is integral with the open dome of the steering casing. In other words, the open dome of the steering casing and the end stop(s) are formed in one piece, for example made of aluminum.

According to one possibility, at least one end stop is made by a foundry process with the open dome.

According to another possibility, at least one end stop is made roughly, without machining alteration, promoting a reduction in the cost of making this or these end stop(s).

In a particular embodiment, several end stops are distributed in a circle around the output shaft.

According to one possibility, several end stops are distributed regularly around the output shaft, with regular angles between each of the several end stops.

According to another possibility, several end stops comprise three end stops distributed regularly around the output shaft, with regular angles of 120 degrees between each of the three end stops.

According to a variant, several end stops comprise two, four, five, six or more end stops.

According to a variant, a single end stop is provided, such an end stop being for example made in the form of a ring.

In a particular embodiment, the output shaft comprises:
a first end portion disposed in the reducer casing and around which the worm wheel is mounted and linked in rotation, and
a second end portion disposed in the steering casing and which extends the pinion;

where the output shaft is rotatably mounted also by means of a second rolling bearing mounted around the second end portion of the output shaft and carried by a second bearing provided on the steering casing.

In an advantageous embodiment, the blocking nut is crimped on the first bearing of the reducer casing.

Indeed, the invention allows using the conventional solution with crimping, without a lock nut, such that, in the case of failure of the crimping (for example due to a poor realization of the latter), the addition of the end stop(s) allows guaranteeing that the blocking nut will not be completely loosened despite the thermal expansion.

The invention also concerns a motor vehicle equipped with a power steering system according to the invention.

Other features and advantages of the present invention will appear on reading the detailed description below, of a non-limiting implementation example, made with reference to the appended figures in which:

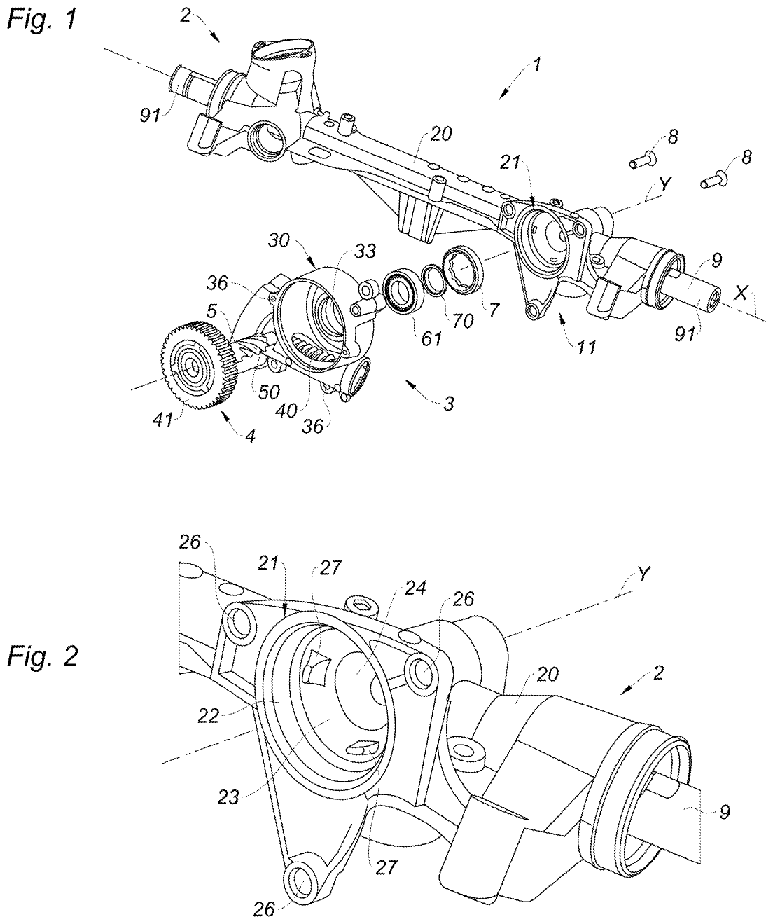

FIG. 1 is a schematic perspective and exploded view of a power steering system according to an exemplary embodiment of the invention;

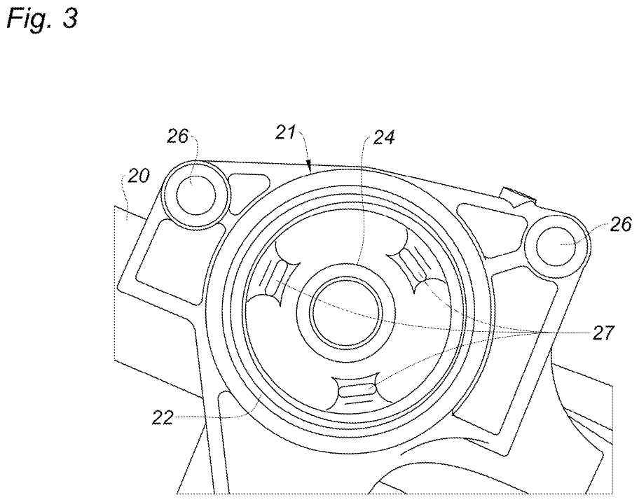

FIG. 2 is a schematic view zoomed in on the area II of FIG. 1, for a closer view of the open dome of the steering casing with the end stops thereof;

FIG. 3 is a schematic sectional view of the power steering system of FIG. 1, according to a section plane sectioning the output shaft in its length;

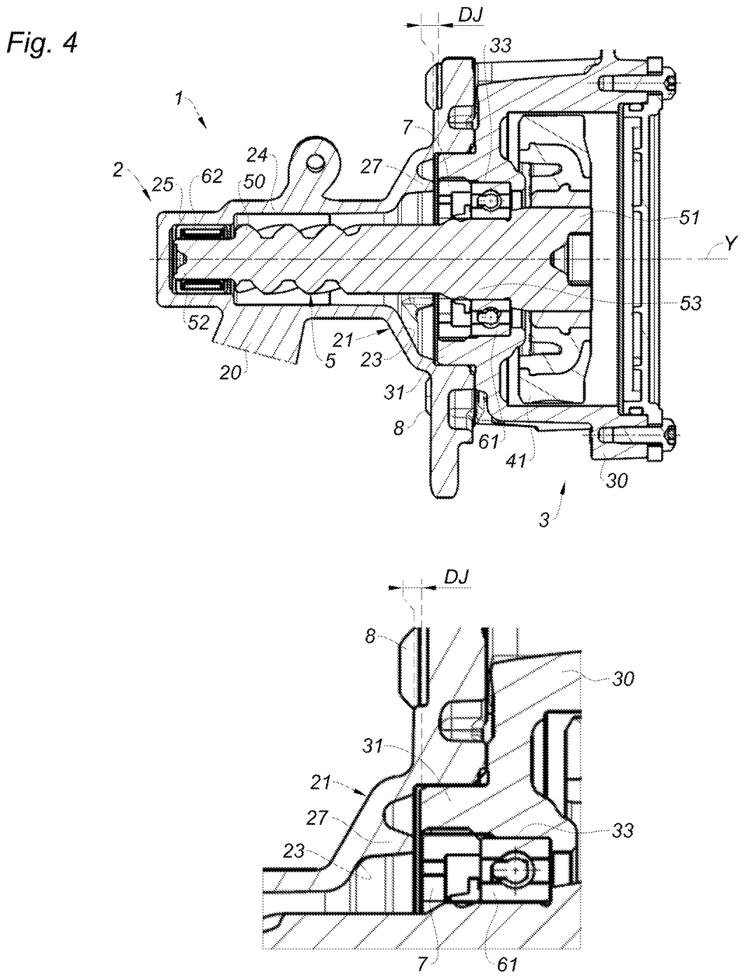

FIG. 4 is a schematic sectional view of the power steering system of FIG. 1, according to another section plane sectioning the output shaft in its length, accompanied by a detailed view on an area showing an end stop and a portion of the blocking nut.

With reference to FIG. 1, a power steering system 1 for a motor vehicle, according to the invention comprises a rack and pinion steering module 2 comprising a steering casing 20 inside which a steering rack 9 is slidably mounted along a longitudinal axis X, where this steering rack 9 is provided with two ends 91 intended to be coupled to respective steering tie rods (not illustrated).

Moreover, this steering casing 20 has an open dome 21 enabling an access to the steering rack 9, where this open dome 21 has at the edge an annular inner bearing 22 extended by an inner face 23 of a frusto-conical shape. This inner face 23 of the open dome 21 is extended by a cylindrical inner conduit 24, extended by a second bearing 25 provided in the steering casing 20 to receive a second rolling bearing 62.

In addition, the steering casing 20 has holes 26 provided around the open dome 21 for the passage of screws 8.

With reference to FIG. 1, the power steering system 1 further comprises an assist module 3 comprising a reducer casing 30 fastened on the open dome 21 of the steering casing 20. More specifically, the reducer casing has a fitting cylinder 31 which is mounted inside the inner bearing 22 of the open dome 21. This fitting cylinder 31 has a first bearing 33 which opens opposite to the inner face 23 of the open dome 21.

Moreover, the reducer casing 30 is fastened on the steering casing 20 by means of screws 8 which pass through the holes 26 to be screwed into holes 36 provided on the reducer casing 30 around the fitting cylinder 31.

The assist module 3 comprises, inside the reducer casing 30, a gear reducer 4 comprising an worm screw 40 driven by an assist motor (not illustrated) and which meshes on a worm wheel 41 linked in rotation to an output shaft 5 provided with a pinion 50 engaged with the steering rack 21; where this output shaft 5 extends along a transverse axis Y which is transverse, even orthogonal, to the longitudinal axis X.

The output shaft 50 comprises:
a first end portion 51 disposed in the reducer casing 30 and around which the worm wheel 41 is mounted and linked in rotation, and
a second end portion 52 disposed in the steering casing 20 and which extends the pinion 50;
the pinion 50 which forms a worm screw portion extending inside the inner conduit 24 of the steering casing 20; and
an intermediate portion 53, between the pinion 50 and the first end portion 51, and which extends between the reducer casing 30 and the steering casing 20.

The output shaft 5 is rotatably mounted inside the reducer casing 30 and the steering casing 20 by means of the following two rolling bearings 61, 62:
a first rolling bearing 61 mounted around the intermediate portion 53 of the output shaft 5 and carried by the first bearing 33 provided inside the fitting cylinder 31 of the reducer casing 30, between the worm wheel 41 and the pinion 50; and
the second rolling bearing 62 mounted around the second end portion 52 of the output shaft 5 and carried by the second bearing 25 provided on the steering casing 20.

There is also provided a blocking nut 7 which is screwed inside the first bearing 33 in abutment against the first rolling bearing 61, and more specifically against an outer cage of the first rolling bearing 61. Thus, this first bearing 33 has a tapped portion for screwing the blocking nut 7, followed by a smooth portion for receiving the first rolling bearing 61, and more specifically the outer cage of the first rolling bearing 61.

An inner nut or an inner washer 70 can also be provided, mounted around the intermediate portion 53 of the output shaft 5, and abutting against the first rolling bearing 61, and more specifically against an inner cage of the first rolling bearing 61; this inner nut or this inner washer 70 thus being surrounded by the blocking nut 7.

The blocking nut 7, once screwed against the first rolling bearing 61, does not exceed the first bearing 33 and is disposed facing the inner face 23 of the open dome 21 of the steering casing 20.

As shown in FIGS. 2 and 3, the reducer casing 20 has several end stops 27 protruding from the inner face 23 of the open dome 21. These end stops 27 are integral with the open dome 21 of the steering casing 20, and they are for example made by an aluminum foundry process with the open dome 21, roughly, that is to say without machining alteration of these end stops 27.

As shown in FIG. 2, these end stops 27 are distributed in a circle regularly about the transverse axis Y (and therefore around the output shaft 5 in situation), with regular angles between each of the end stops 27. In the non-limiting example illustrated in the Figures, the end stops 27 are three and are regularly distributed in a circle, with regular angles of 120 degrees between each of the three end stops 27.

As shown in FIGS. 3 and 4, these end stops 27 are disposed facing the blocking nut 7 at a predetermined distance DJ (distance measured parallel to the transverse axis Y—shown in FIG. 5) allowing a stop of the blocking nut 7 in the case of unscrewing, such that this blocking nut 7 can be unscrewed only partially before being stopped against these end stops 7.

In other words, the blocking nut 7 has an unscrewing length which corresponds to the length required for the blocking nut 7 to be completely unscrewed and therefore to be lost out of the first bearing 33, and the distance DJ is less than this unscrewing length, such that the blocking nut 7 cannot travel this unscrewing length and therefore cannot be lost, because the blocking nut 7 will abut against the end stops 27 only after having traveled this distance DJ.

In the case where the blocking nut 7 is almost flush with the beginning of the tapped portion of the first bearing 33, then the unscrewing length is almost equivalent to the width of the blocking nut 7. Advantageously, the distance DJ is less than 0.25 times the unscrewing length, or even in the range of 0.1 to 0.2 times the unscrewing length.

1. A power steering system for a motor vehicle, comprising:
a steering module comprising a steering casing inside which a steering rack is slidably mounted, having two ends provided to be coupled to respective steering tie rods, in which the steering casing has an open dome enabling an access to the steering rack; and
an assist module comprising a reducer casing fastened on the open dome of the steering casing and inside which a gear reducer is mounted, comprising a worm screw driven by an assist motor and which meshes on a worm wheel linked in rotation to an output shaft provided with a pinion engaged with the steering rack, said output shaft being rotatably mounted inside the reducer casing and the steering casing by means of at least one first rolling bearing carried by a first bearing provided on the reducer casing between the worm wheel and the pinion, and a blocking nut is screwed inside the first bearing in abutment against the first rolling bearing, said blocking nut being disposed facing an inner face of the open dome of the steering casing;
said power steering system being characterized in that the reducer casing has at least one end stop protruding from the inner face of the open dome and disposed facing the blocking nut at a predetermined distance (DJ) allowing the blocking nut to stop in the case of loosening, such that said blocking nut can be loosened only partially before being stopped against said at least one end stop.

2. The power steering system according to claim 1, wherein at least one end stop is integral with the open dome of the steering casing.

3. The power steering system according to claim 2, wherein at least one end stop is made by a foundry process with the open dome.

4. The power steering system according to claim 3, wherein at least one end stop is made roughly, without machining alteration.

5. The power steering system according to claim 1, comprising several end stops distributed in a circle around the output shaft.

6. The power steering system according to claim 5, wherein several end stops are distributed regularly around the output shaft, with regular angles between each of the several end stops.

7. The power steering system according to claim 6, wherein several end stops comprise three end stops distributed regularly around the output shaft, with regular angles of 120 degrees between each of the three end stops.

8. The power steering system according to claim 1, wherein the output shaft comprises:
a first end portion disposed in the reducer casing and around which the worm wheel is mounted and linked in rotation, and
a second end portion disposed in the steering casing and which extends the pinion;
wherein said output shaft is rotatably mounted also by means of a second rolling bearing mounted around the second end portion of the output shaft and carried by a second bearing provided on the steering casing.

9. The power steering system according to claim 1, wherein the blocking nut being crimped on the first bearing of the reducer casing.

10. The motor vehicle equipped with a power steering system according to claim 1.
